(19) United States
(12) Patent Application Publication
(10) Pub. No.: US 2008/0070107 A1
(43) Pub. Date: Mar. 20, 2008

(54) Separator and Non-Aqueous Electrolyte Secondary Battery Using Same

(76) Inventors: Shinji Kasamatsu, Osaka (JP); Mikinari Shimada, Kyoto (JP)

Correspondence Address: MCDERMOTT WILL & EMERY LLP, 600 13TH STREET, NW, WASHINGTON, DC, 20005-3096, US

(21) Appl. No.: 11/663,810

(22) PCT Filed: Sep. 16, 2005
(86) PCT No.: PCT/JP05/17143

§ 371 Date: Mar. 26, 2007

(30) Foreign Application Priority Data
Dec. 7, 2004 (JP) 2004-354471

(51) Int. Cl. H01M 2/16

(52) U.S. Cl. 429/144

(57) ABSTRACT

A separator including at least a layer containing a fine particulate filler and a shutdown layer. The fine particulate filler includes a joined-particle filler that is in the form of a plurality of primary particles joined and bonded to one another. A non-aqueous electrolyte secondary battery including this separator exhibits improved safety, high performance and large current discharge capability particularly at low temperatures.

### TECHNICAL FIELD

The present invention relates to a non-aqueous electrolyte secondary battery, and more particularly to a separator therefor. More specifically, this invention relates to an improved separator to achieve a high performance non-aqueous electrolyte secondary battery having enhanced safety and to a non-aqueous electrolyte secondary battery comprising the separator.

### BACKGROUND ART

In general, secondary batteries (electrochemical batteries) such as lithium ion secondary batteries include an electrode group comprising a positive electrode, a negative electrode and a separator for electrically insulating the positive and negative electrodes from each other and for retaining electrolyte.

The separator functions to prevent a short-circuit between the positive and negative electrodes during normal operation so as to ensure safety of the battery. Separators for use in non-aqueous electrolyte secondary batteries have a special function. Particularly, separators comprising a thermoplastic resin such as porous polyolefin have so-called “shutdown function”, whereby if the battery temperature rises rapidly due to an excessive current flow caused by an external short-circuit, the porous separator softens to make the separator substantially nonporous and thereby to stop the current. If the battery temperature keeps rising even after the shutdown, the separator melts and heat-shrinks, forming large pores and causing a short-circuit between the positive and negative electrodes (hereinafter referred to as “meltdown”). The higher the temperature at which this meltdown occurs, the higher the safety.

If thermal meltability is enhanced to reinforce the shutdown function, the meltdown temperature decreases. As a result, the battery temperature increases due to Joule heat generated by a short-circuit current caused by a short-circuit between the positive and negative electrodes, and the battery safety is impaired. An outstanding problem was to solve this contradiction.

To solve this problem, various separators have been proposed including a separator comprising a thermoplastic resin such as porous polyolefin, a separator comprising a composite film having a highly heat-resistant layer for preventing a short-circuit caused by heat shrinkage even in a high temperature condition, etc. For example, one of the proposed separators is a separator having a matrix material composed of inorganic particles and an organic material such as polyethylene oxide applied onto the surface of the separator (see Patent Document 1). Another is a separator comprising a polyolefin resin and inorganic powders (see Patent Document 2).

There is also proposed a separator comprising a porous film and a layer comprising a nitrogen-containing heat resistant aromatic polymer and ceramic powders (see Patent Document 3). Proposals are also made on an electrode coated with a layer made of a matrix material capable of preventing the heat shrinkage (see Patent Document 4).

Patent Document 1: Japanese Laid-Open Patent Publication No. 2001-319634

Patent Document 2: Japanese Laid-Open Patent Publication No. Hei 10-50287

Patent Document 3: Japanese Patent No. 3175730

Patent Document 4: Japanese Patent No. 3371301

### DISCLOSURE OF THE INVENTION

### Problem To be Solved by the Invention

Although the use of a separator having a layer including inorganic particles as a filler that functions to prevent the heat shrinkage can improve the safety of the battery particularly in the event of an internal short-circuit as in a nail penetration test, the battery tends to exhibit poor charge/discharge characteristics. Particularly when the battery is charged or discharged with a relatively large current which is a possible operating environment for cell phones and notebook computers, the battery performance degrades significantly in an environmental condition of, for example, 0° C. or lower. This has been an important practical issue. This problem occurs because of the following reason. In a conventional porous film containing a filler comprising dispersed primary particles, the primary particles are densely filled during the formation of the porous film, forming no large pores between the particles. Accordingly, the porosity which indicates the volume ratio of voids in the porous film decreases. As a result, high rate charge/discharge characteristics are impaired, and charge/discharge in a low temperature environment may not be performed.

An object of the present invention is to provide an improved separator for a non-aqueous electrolyte secondary battery comprising a layer including a fine particulate filler and a shutdown layer.

Another object of the present invention is to provide a non-aqueous electrolyte secondary battery comprising the separator that exhibits improved safety, high performance and large current discharge capability particularly at low temperatures.

### Means for Solving the Problem

In order to solve the above problem, the separator of the present invention comprises at least a layer including a fine particulate filler and a shutdown layer, wherein the fine particulate filler comprises a joined-particle filler that is in the form of a plurality of primary particles that are joined and bonded to one another.

A layer comprising a fine particulate filler is usually produced as follows. A slurry for forming a porous film is first prepared by mixing a powdered filler and a resin or a heat resistant resin serving as a binder with a solvent using a dispersing machine. During this process, the fine particulate filler material is supplied in the form of powders. The fine particulate filler usually comprises mainly spherical primary particles and powders comprising primary particles loosely aggregated by van der Waals force (aggregation force) between the primary particles. FIG. 4 is a schematic diagram of non-joined particle fillers 2 mainly comprising spherical primary particles. An aggregate of primary particles is indicated by the reference number 3.

In the preparation of the slurry, the filler is dispersed into as uniform primary particles as possible using a dispersing machine such as a bead mill so as to form a porous film having a constant thickness and a constant porosity. When a film is formed using a slurry for forming a porous film containing the filler in which primary particles are dispersed, the primary particles tend to be densely packed in the formed film. Even if the primary particles are aggregated, because they can easily break up, the fine particles are densely filled into the film, and thus the porosity which indicates the volume ratio of voids in the porous film decreases. As a result, high rate charge/discharge characteristics are impaired, and charge/discharge in a low temperature environment may not be performed.

In the present invention, a fine particulate filler comprising joined particles that are in the form of a plurality of primary particles joined and bonded to one another is used as a material for forming the porous film. The use of such fine particulate filler provides a fine particulate filler-containing layer having an improved porosity, large current charge/discharge characteristics which has been a conventional problem can be enhanced significantly.

Instead of the fine particulate filler material comprising primary particles aggregated by van der Waals force or dry-bonded which can easily disintegrate into primary particles during dispersing process as described above, the present invention employs joined particles that are in the form of a plurality of primary particles that are joined and bonded to one another. Therefore, a porous film having an extremely high porosity can be formed easily.

Because a filler comprising joined particles that are in the form of a plurality of primary particles that are joined and bonded to one another is used, the filler particles having a three-dimensionally joined structure interact during the formation of the porous film, and therefore highly dense packing of the particles can be prevented. For this reason, it is possible to form a porous film having an unprecedentedly high porosity.

Preferably, the joined particles used in this invention each comprise primary particles partially melted and bonded to one another by a heat treatment. FIG. 2 is a schematic diagram showing the joined particles 1. The particles having such morphology do not disintegrate even when strong shearing force is applied by a dispersing machine which is usually used for the preparation of a slurry for forming a porous film. Accordingly, it is possible to form a porous film having a constant porosity.

The fine particulate filler preferably comprises at least one metal oxide selected from alumina, titanium oxide, zirconium oxide, magnesium oxide, zinc oxide and silicon dioxide because the metal oxides are easily obtainable. Alumina, titanium oxide, zirconium oxide, magnesium oxide, zinc oxide and silicon dioxide are particularly preferred because they are chemically stable. These metal oxides having a high purity are particularly stable. Further, these metal oxides are not affected by electrolyte or oxidation reduction potential in the battery, and they do not cause any side reaction that can harm battery performance.

The fine particulate filler-containing layer is a porous film containing the fine particulate filler and a binder, or a heat resistant porous film containing the fine particulate filler and a heat resistant resin binder.

Nail penetration test is a test for evaluating the safety of batteries in which a battery is penetrated or pierced from its side with a nail to induce an internal short-circuit. By inserting a nail through a battery, a short circuit occurs inside the battery, allowing a short circuit current to flow into the short-circuited area and generating Joule heat. Due to this Joule heat, a conventionally used separator having a shutdown layer heat-shrinks, allowing the short-circuited area to expand between the positive and negative electrodes. This prolongs the short circuit between the positive and negative electrodes, which may cause the battery to overheat to 180° C. or higher. In contrast, in a porous film containing the fine particulate filler and a binder, because the fine particulate filler is highly heat resistant, the heat shrinkage of the separator can be prevented without causing any heat shrinkage caused by Joule heat generated by a short circuit, inducing any shape change such as thermal decomposition or inducing any chemical reaction. Thereby, it is possible to obtain a battery having excellent safety and free from overheating even when an internal short-circuit occurs as in a nail penetration test.

Likewise, in a separator having a heat resistant porous film containing the fine particulate filler and a heat resistant resin, because both the fine particulate filler and the heat resistant resin do not induce any heat shrinkage, any shape change such as thermal decomposition or any chemical reaction at a battery temperature of 180° C. or lower, the heat shrinkage of the separator can be prevented. Thereby, it is possible to obtain a battery having excellent safety and free from overheating even when an internal short-circuit occurs as in a nail penetration test.

In the porous film containing the fine particulate filler and a binder, the amount of the binder is preferably not less than 1.5 parts by weight and not greater than 10 parts by weight relative to 100 parts by weight of the fine particulate filler. When the amount of the binder is 1.5 parts by weight or greater, the formed porous film containing the fine particulate filler and the binder exhibits sufficiently high adhesion strength to the shutdown layer. Accordingly, even when the meltdown phenomenon occurs in the shutdown layer in a high temperature condition during a short-circuit of the battery, the porous film containing the fine particulate filler and the binder does not separate from the shutdown layer, and thus a high level of safety can be ensured. When the amount of the binder exceeds 10 parts by weight, because the amount of the fine particulate filler decreases, sufficient heat resistance cannot be ensured, which may allow the shutdown layer to heat-shrink in a high temperature condition. When the amount of the binder is 10 parts by weight or less relative to 100 parts by weight of the fine particulate filler, on the other hand, excellent battery performance can be obtained because a significant reduction in porosity of the porous film containing the fine particulate filler and the binder caused by increasing the amount of the binder does not occur.

The heat resistant porous film preferably comprises a heat resistant resin having a heat deflection temperature of 180° C. or higher determined by deflection temperature measurement under load of 1.82 MPa according to ASTM-D648 defined by American Society for Testing and Materials.

When a battery is subjected to an internal short-circuit test such as nail penetration test or heating test in which the battery is heated to 150° C., there is a possibility that the battery temperature might rise to about 180° C. due to heat accumulation phenomenon caused by chemical reaction heat in the battery. Although the heat shrinkage of the separator can be prevented by including the heat resistant porous film, when the heat resistant porous film comprises a heat resistant resin having a heat deflection temperature of 180° C. or higher, the separator hardly heat-shrinks even under the heat accumulation phenomenon. As a result, the occurrence of short-circuit inside the battery can be prevented, and thus it is possible to provide a safe battery free from overheating.

The amount of the heat resistant resin is preferably not less than 10 parts by weight and not greater than 200 parts by weight relative to 100 parts by weight of the fine particulate filler. Since the heat resistant porous film contains the fine particulate filler comprising a metal oxide having a high melting temperature and the heat resistant resin having a high heat deflection temperature, a high level of safety can be ensured. As such, the amount of the heat resistant resin is not limited to a small amount. However, when the amount of the heat resistant resin is less than 10 parts by weight relative to 100 parts by weight of the fine particulate filler, because the adhesion strength of the heat resistant resin is smaller than that of binders made of a fluorocarbon resin, an elastomeric polymer having rubber elasticity and a polyacrylic acid derivative, the formed porous film containing the fine particulate filler and the heat resistant resin exhibits less sufficient adhesion strength to the shutdown layer. For this reason, when the meltdown phenomenon occurs in the shutdown layer in a high temperature condition during a short-circuit of the battery, the porous film containing the fine particulate filler and the heat resistant resin separates from the shutdown layer, which may fail to sufficiently prevent the shutdown layer from heat-shrinking. When the amount of the heat resistant resin is 200 parts by weight or less relative to 100 parts by weight of the fine particulate filler, a significant reduction in porosity of the porous film resulting from the reduction of the amount of the fine particulate filler does not occur, and thus excellent battery performance can be obtained.

The shutdown layer is a porous film made of a thermoplastic resin and having pores that allow ions to pass through. At a temperature of 80 to 180° C., the shutdown layer can turn into a substantially nonporous layer, which inhibits ions to pass through.

Even when the battery temperature increases significantly by an excessive current caused by an external short-circuit, the porous separator having the porous film softens and becomes substantially nonporous, so that the current is shut down. As a result, safety can be ensured.

### EFFECT OF THE INVENTION

According to the present invention, it is possible to provide a non-aqueous electrolyte secondary battery having improved safety, high performance and large current discharge capability particularly at low temperatures.

### BRIEF DESCRIPTION OF THE DRAWINGS

FIG. 1 is a cross sectional view of a relevant part of a separator according to an example of the present invention.

FIG. 2 is a schematic diagram of a joined-particle filler used in an example of the present invention.

FIG. 3 is an SEM image showing a layer containing a fine particulate filler according to an example of the present invention.

FIG. 4 is a schematic diagram of a conventional non-joined particle filler.

FIG. 5 is an SEM image showing a layer containing a conventional fine particulate filler.

### BEST MODE FOR CARRYING OUT THE INVENTION

The separator of the present invention comprises: at least a layer comprising a fine particulate filler; and a shutdown layer, wherein the fine particulate filler comprises a joined-particle filler that is in the form of a plurality of primary particles that are joined and bonded to one another.

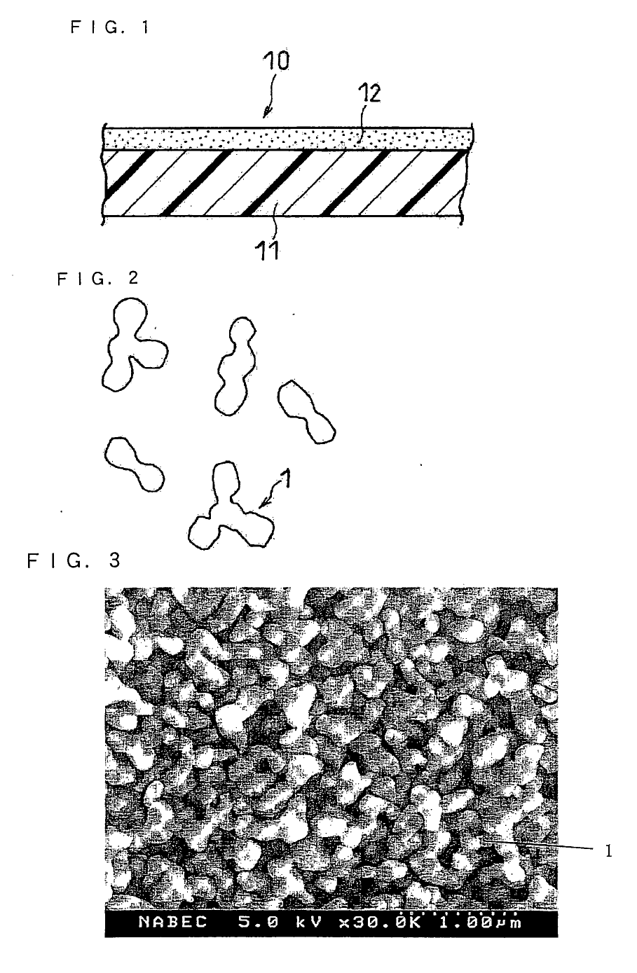

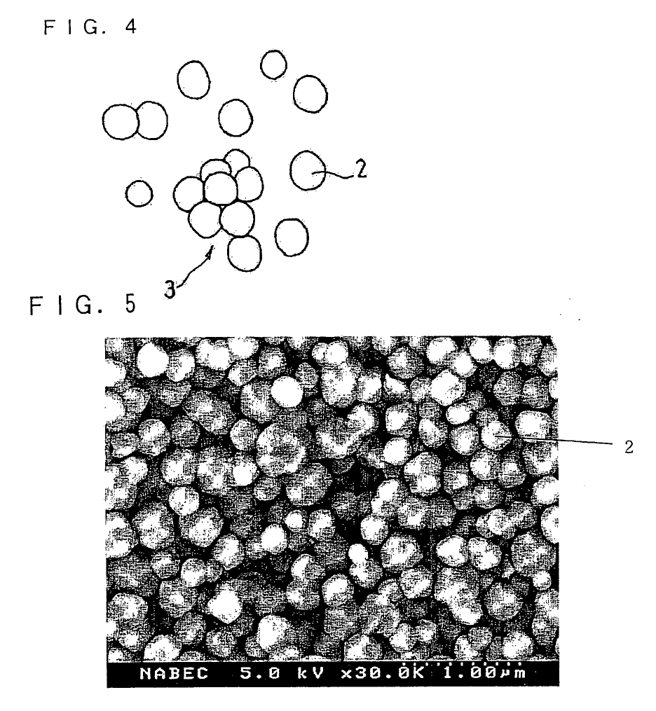

FIG. 1 shows a separator according to an embodiment of the present invention. The separator 10 comprises a shutdown layer 11 and a layer containing a fine particulate filler 12. The shutdown layer 11 is a porous film made of a thermoplastic resin. The layer 12 comprises a fine particulate filler and a heat resistant resin.

Preferred embodiments of the present invention are described below.

It is generally considered that the large current behavior of non-aqueous electrolyte secondary batteries including an electrode plate having a porous film as a separator in a low temperature environment (e.g., 2C discharge characteristics at 0° C.) depends on the porosity of the separator, particularly on the porosity of the fine particulate filler-containing layer.

In this connection, the effect of the present invention obtained by the “porosity” formed by the fine particulate filler contained in the fine particulate filler-containing layer will be described below.

The porosity is measured by the following procedure, for example.

A fine particulate filler comprising dendritic particles, each comprising a plurality of primary particles bonded to one another, is mixed with a binder in a solvent, which is then dispersed with a bead mill. The resultant is then passed through a filter having appropriately fine holes to obtain a slurry or paste for forming the porous film. This slurry or paste is applied onto a metal foil by a doctor blade to a specified thickness, which is then dried to obtain a test piece. The porosity of the formed film on the test piece is calculated. For the calculation, the weight and thickness of the film are first measured. Then, the solid volume is determined from the true density of the filler, the true density of the binder and the mixing ratio of the filler and the binder. The resultant is then divided by the entire volume of the porous film to obtain a volume ratio. From this volume ratio, the porosity of the porous film on the test piece can be determined.

When a conventional fine particulate filler was used, because the primary particles disintegrated easily, the formed porous film almost always exhibited a low porosity of 45% or less. The formation of a porous film having a porosity higher than the above value was difficult. In a porous film having such a low porosity, lithium ions cannot easily pass through the porous film in a low temperature environment where the viscosity of electrolyte and the conductivity decrease. In this case, when such porous film is applied to a lithium ion secondary battery, the lithium ion secondary battery cannot offer satisfactory 2C discharge characteristics at 0° C.

In contrast, when a joined-particle filler 1 of the present invention comprising a plurality of particles joined to one another as shown in FIG. 2 is used as a filler, a porous film having a porosity of 45% or greater can be obtained easily. The porous film containing a filler comprising such joined particles exhibits a high porosity even when a metal oxide such as titanium oxide, alumina, zirconium oxide, magnesium oxide, zinc oxide or silicon dioxide is used as the fine particulate filler material.

The fine particulate filler preferably comprises only a joined-particle filler that is in the form of a plurality of primary particles that are joined and bonded to one another. However, as long as the fine particulate filler comprises not less than 20 wt % of the joined-particle filler, the fine particulate filler may further comprise spherical or nearly spherical primary particles and aggregated particles thereof.

Preferably, the joined-particle filler comprises at least two primary particles on average, and more preferably not less than 4 and not greater than 30 primary particles. For example, when five joined-particle fillers are analyzed for the number of primary particles contained in a single joined particle from a scanning electron microscope (SEM) image, the average is preferably not less than two, and more preferably not less than 4 and not greater than 30 primary particles.

The joined particles having the above number of primary particles are also effective when they are used together with, instead of the binder, the heat-resistant resin to form a heat resistant porous film. This is a useful technique for enhancing the porosity of the porous film which had been considered difficult.

When the primary particles for forming the joined particles used in the present invention have an excessively large particle size, a short-circuit tends to occur during the production of a battery. Accordingly, the maximum particle size of the primary particles is preferably 3 μm or less. The maximum particle size can be measured by, for example, a wet type laser particle size distribution analyzer manufactured by Microtrac Inc. Further, because the primary particles are mostly made of a homogeneous material, and there is almost no difference between a volume based size and a weight based size in the particle size distribution measurement, the 99% value (D99) based on volume or weight can be regarded as the maximum particle size.

When the joined particles comprising primary particles having a primary particle size of over 3 μm are used, the particles settle more quickly in the slurry for forming the film, resulting in a nonuniform distribution of the filler in the fine-particulate filler-containing layer. Thus, satisfactory porosity cannot be ensured throughout the entire layer, and the battery performance tends to decrease.

Conversely, when the joined particles used in the present invention have an excessively large particle size, the large particles may stick to the application blade of a blade coater, for example, during the formation of a porous film having a thickness of 20 μm or less (the thickness normally required in designing) in the production process of the battery, creating thin streaks on the coating film and reducing the production yield significantly. Accordingly, the joined-particle filler preferably has an average particle size of 10 μm or less. More preferably, the thickness of the coating film is twice the particle size or greater because the advantageous effect of the present invention appears significantly.

Similar to the case of the primary particles, the average particle size of the joined-particle filler can be measured by, for example, a wet type laser particle size distribution analyzer manufactured by Microtrac Inc. Because the primary particles are mostly made of a homogeneous material and there is almost no difference between a volume based size and a weight based size in the particle size distribution measurement, the 50% value (D50) based on volume or weight can be regarded as the average particle size.

Most non-aqueous electrolyte secondary batteries have a porous film thickness of 20 μm or less which is determined by practical battery design. The method for producing the separator comprising the fine particulate filler-containing layer and the shutdown layer is not limited to any particular method. For example, a method is used in which a solvent having the fine particulate filler dispersed therein is applied onto the shutdown layer by means of a die nozzle or blade.

When the joined-particle filler having a size exceeding 10 μm are used to form a porous film having a thickness of 20 μm by means of a blade, for example, some aggregated particles may stick in the space between the electrode plate surface and the tip of the blade, creating streaks and reducing the production yield of the porous film.

Considering the production of the porous film, the joined-particle filler preferably has an average particle size of 10 μm or less.

As explained previously, the joined particles are preferably partially melted and bonded to one another by a heat treatment. The present inventors investigated various methods for joining a plurality of primary particles into a joined particle, and they ascertained that an aggregated particle produced by mechanical shearing and an aggregated particle produced using a binder disintegrate into primary particles in a dispersing machine during the process of preparing a slurry for forming the film. A joined particle produced by joining primary particles by heating, on the other hand, does not disintegrate even when it is dispersed by a common dispersion method such as bead milling. Accordingly, this is more preferred.

The fine particulate filler preferably comprises at least one metal oxide selected from alumina, titanium oxide, zirconium oxide, magnesium oxide, zinc oxide and silicon dioxide. If an attempt is made to produce a joined particle using metal particles instead of metal oxide, the control of the heating atmosphere will be difficult and the cost will be very high. Further, when the joined particle produced as above is used to produce a battery, unless the oxidation reduction potential is not considered, the metal particles can leach into the electrolyte and deposit onto an electrode, forming dendrites which can cause a short-circuit. Accordingly, the battery design will be difficult. In the case of using resin fine particles, when they are used to produce a joined particle, it is difficult to bring the production cost and quantity to practical levels. Accordingly, the use of metal oxide is most advantageous from an industrial standpoint. Examples of the metal oxide include alumina, titanium oxide, zirconium oxide, magnesium oxide, zinc oxide, silicon dioxide, silicon monoxide and tungsten oxide. Among them, alumina, titanium oxide, zirconium oxide, magnesium oxide, zinc oxide and silicon dioxide are particularly preferred because they are chemically stable. These metal oxides having a high purity are particularly stable. Further, these metal oxides are not affected by an electrolyte or oxidation reduction potential in the battery, and they do not cause a side reaction that can harm battery performance.

When the fine particulate filler-containing layer is a porous film containing a fine particulate filler and a binder, as the binder, a binder having resistance to electrolytes can be used. Preferred examples include a fluorocarbon resin, an elastomeric polymer having rubber elasticity and a polyacrylic acid derivative. A preferred example of the fluorocarbon is polyvinylidene fluoride (PVDF). A preferred example of the elastomeric polymer is a polymer containing a polyacrylonitrile unit. The use of such material as the binder imparts further flexibility to the layer containing the fine particulate filler and the binder, and therefore cracking and the separation of the porous film do not occur easily.

When the fine particulate filler-containing layer is a heat resistant porous film containing a fine particulate filler and a heat resistant resin, a resin having sufficient heat resistance and resistance to electrolytes is used as the heat resistant resin. The heat resistance of the resin can be evaluated using a heat deflection temperature determined by deflection temperature measurement under load of 1.82 MPa according to the test method ASTM-D648. In this case, it is preferred to use a heat resistant resin having a heat deflection temperature of 180° C. or higher. This is because, in an internal short-circuit test such as nail penetration test or a heating test at 150° C., the battery temperature can rise to about 180° C. due to heat accumulation phenomenon caused by heat generated by a chemical reaction in the battery. However, the inclusion of the heat resistant porous film prevents the separator from heat-shrinking. When the heat resistant resin of the heat resistant porous film has a heat deflection temperature of 180° C. or higher, the heat-shrinkage of the separator hardly occurs even under the heat accumulation phenomenon. Accordingly, a short-circuit inside the battery can be prevented and a safe battery free from overheating can be obtained.

The heat resistant resin is not limited as long as it has the above property. Examples include aramid, polyimide, polyamide imide, polyphenylene sulfide, polyether imide, polyethylene terephthalate, polyether nitrile, polyether ether ketone, polybenzoimidazole and polyarylate. Among them, particularly preferred are aramid, polyimide and polyamide imide because they have a high heat deflection temperature of not less than 260° C.

The shutdown layer is a porous film comprising a thermoplastic resin capable of turning into a substantially nonporous layer at a temperature of 80 to 180° C. In a battery containing such porous film, when the battery temperature rises sharply by an excessive current caused by an external short-circuit, the porous film softens to make the film nonporous, so that safety can be ensured. Although the thermoplastic resin for use in the shutdown layer is not specifically limited as long as it has a softening point of 80 to 180° C., a microporous film comprising a polyolefin resin is preferred in terms of chemical resistance and workability. As the polyolefin resin, polyethylene or polypropylene can be used. The shutdown layer can be a monolayer film comprising a single polyolefin resin or a multilayer film comprising two different types of polyolefin resins. The thickness of the shutdown layer is not specifically limited, but the shutdown layer preferably has a thickness of 8 to 30 μm to maintain the design capacity of the battery.

It is effective that the separator having the fine particulate filler-containing layer and the shutdown layer is used in a non-aqueous electrolyte secondary battery, specifically, a lithium ion secondary battery. This is because lithium ion secondary batteries, which contain an electrolyte comprising a flammable organic non-aqueous solvent, are required to have a high level of safety. By using the separator of the present invention, it is possible to impart a high level of safety to lithium ion secondary batteries.

The positive electrode for a lithium ion secondary battery is formed by placing a material mixture containing at least a positive electrode active material comprising a lithium composite oxide, a binder and a conductive material on a positive electrode current collector.

Preferred examples of the lithium composite oxide include: lithium cobalt oxide (LiCoO₂); modified forms of lithium cobalt oxide; lithium nickel oxide (LiNiO₂); modified forms of lithium nickel oxide; lithium manganese oxide (LiMn₂O₂); modified forms of lithium manganese oxide; any of the above-listed oxides in which Co, Ni or Mn is partially replaced with other transition metal element, or with a typical metal such as aluminum or magnesium; and compounds containing iron as the main constituent element which are referred to as olivinic acid.

The binder for use in the positive electrode is not specifically limited. There can be used polytetrafluoroethylene (PTFE), modified forms of PTFE, PVDF, modified forms of PVDF, and modified acrylonitrile rubber particles (e.g., BM-500B (trade name) available from Zeon Corporation, Japan). Preferably, PTFE and BM-500B are used together with a thickener such as CMC, polyethylene oxide (PEO) or a modified acrylonitrile rubber (e.g. BM-720H (trade name) available from Zeon Corporation, Japan).

As the conductive material, acetylene black, ketjen black and various graphites can be used. They may be used singly or in any combination of two or more.

The positive electrode current collector can be a metal foil which is stable under a positive electrode potential such as an aluminum foil, or a film having a metal (e.g., aluminum) placed on the surface thereof. The surface of the positive electrode current collector may be roughened to form recesses and projections or the current collector may be punched.

The negative electrode for a lithium ion secondary battery is formed by placing a material mixture containing at least a negative electrode active material capable of absorbing and releasing lithium ions, a binder and optionally a thickener on a negative electrode current collector.

As the negative electrode active material, there can be used carbon materials such as various natural graphites, various artificial graphites, petroleum coke, carbon fiber and baked organic polymers; composite materials containing silicon or tin such as oxide or siliside; various metals; and various alloy materials.

Although not specifically limited, rubber particles are preferably used as the binder for use in the negative electrode because even a small amount thereof can provide sufficient binding capability. Particularly, those containing a styrene unit and a butadiene unit are preferred such as styrene-butadiene copolymer (SBR) and modified forms of SBR.

When rubber particles are used as the negative electrode binder, a thickener composed of a water-soluble polymer is preferably used together with the rubber particles. The water-soluble polymer is preferably a cellulose resin, particularly CMC. Alternatively, PVDF or a modified form of PVDF can be used as the negative electrode binder.

The negative electrode binder comprising the rubber particles and the thickener comprising the water-soluble polymer are preferably contained in the negative electrode in an amount of 0.1 to 5 parts by weight per 100 parts by weight of the negative electrode active material.

As the negative electrode current collector, a metal foil which is stable under a negative electrode potential such as a copper foil, or a film having a metal (e.g., copper) placed on the surface thereof can be used. The surface of the negative electrode current collector may be roughened to form recesses and projections or the current collector may be punched.

The non-aqueous electrolyte of the lithium ion secondary battery is prepared by dissolving a lithium salt in an organic non-aqueous solvent as described previously. The concentration of the lithium salt dissolved in the non-aqueous solvent is usually 0.5 to 2 mol/L.

As the lithium salt, preferred are lithium hexafluorophosphate (LiPF₆), lithium perchlorate (LiClO₄) and lithium tetrafluoroborate (LiBF₄). As the non-aqueous solvent, preferred are ethylene carbonate (EC), propylene carbonate (PC), dimethyl carbonate (DMC), diethyl carbonate (DEC) and ethyl methyl carbonate (EMC). The non-aqueous solvent preferably comprises a combination of two or more of those listed above.

In order to form a satisfactory film on an electrode so as to ensure stability during overcharge, it is preferred to add, to the non-aqueous electrolyte, vinylene carbonate (VC), cyclohexyl benzene (CHB) or a modified form of VC or CHB.

### EXAMPLE

The following describes examples of the present invention, but it should be understood that the examples given below are merely illustrative and the scope of the present invention is not limited thereto.

A raw material powder of alumina (primary particles) having an average particle size of 0.1 μm was sintered at 1100° C. for 20 minutes, which was then sized using a wet type ball mill having 15 mm diameter alumina balls therein. Thereby, a joined-particle filler having an average particle size of 0.5 μm was obtained. This filler in an amount of 100 parts by weight was mixed with 4 parts by weight of a polyacrylic acid derivative (MB-720H available from Zeon Corporation, Japan) as a binder and N-methyl-2-pyrrolidone (NMP) as a solvent, which was then adjusted to have a nonvolatile content of 60 wt % using a stirrer. The resultant was dispersed in a bead mill having an internal volume of 0.6 L, 80% of which was filled with 0.2 mm diameter zirconia beads. Thereby, a paste for forming the porous film was obtained. The paste prepared in this example was referred to as paste A1.

The paste A1 was applied in a thickness of about 20 μm onto a metal foil using a doctor blade so as to prepare a test piece. For the calculation of the porosity of the porous film of this test piece, the weight and thickness of this porous film was measured. Then, the solid volume was determined from the true density of the filler, the true density of the binder and the mixing ratio of the filler and the binder. The resultant was then divided by the entire volume of the porous film to obtain a volume ratio. From this volume ratio, the porosity of the porous film was determined.

FIG. 3 shows a scanning electron microscope image (SEM image) of the test piece having the paste A1 applied thereon. It clearly shows that the joined-particle filler 1 forms large voids, indicating that the test piece has a high porosity.

Another paste for forming the porous film was prepared in the same manner as the paste A1 was prepared except that titanium oxide (primary particles) having an average particle size of 0.1 μm was used as the raw material powder. In the same manner as above, the porosity was determined. The paste obtained here was referred to as paste A2.

In the same manner as above, another pastes for forming the porous film A3, A4, A5, A6 and A7 were prepared in the same manner as the paste A1 was prepared except that zirconium oxide, magnesium oxide, zinc oxide, silicon dioxide and silicon monoxide, each (primary particles) having an average particle size of 0.1 μm, were used as the raw material powder, respectively. In the same manner as above, the porosities were determined.

For comparison, a paste for forming the porous film B1 was prepared in the same manner as the paste A1 was prepared except that, instead of the joined-particle filler, a fine particulate filler made of alumina having a size of 0.5 μm was used. Then, the porosity was determined in the same manner as above. FIG. 5 shows an SEM image of the test piece having the paste B1 applied thereon. It shows that nearly spherical non-joined particle fillers 2 are close to one another and thus large voids are not formed between the particles. This indicates that the film containing a filler comprising such particles does not have a high porosity.

For further comparison, a filler comprising aggregated particles having an average particle size of 0.5 μM was prepared by applying mechanical shear to a raw material powder of alumina (primary particles) having an average particle size of 0.1 μm using a vibration mill having a 40 mm diameter alumina bar. Then, a paste for forming the porous film B2 was prepared in the same manner as the paste A1 was prepared except that this filler comprising aggregated particles was used instead of the joined-particle filler of the paste A1. The porosity was then determined in the same manner as above.

Further, another filler comprising aggregated particles having an average particle size of 0.5 μm was prepared by mixing alumina (primary particles) having an average particle size of 0.1 μm with 4 wt % of PVDF binder. A paste for forming the porous film B3 was prepared in the same manner as the paste A1 was prepared except that this filler comprising aggregated particles was used instead of the joined-particle filler of the paste A1. Then, the porosity was measured in the same manner as above.

FIG. 1 shows the results for the above-prepared pastes.

TABLE 1

| | | Primary | Secondary | |
|---|---|---|---|---|
| | Fine particulate | particle size | particle size | Porosity |
| Paste | filler material | (μm) | (μm) | (vol %) |
| A1 | Alumina joined | 0.1 | 0.5 | 60 |
| | particles | | | |
| A2 | Titanium oxide | 0.1 | 0.5 | 58 |
| | joined particles | | | |
| A3 | Zirconium oxide | 0.1 | 0.5 | 56 |
| | joined particles | | | |
| A4 | Magnesium oxide | 0.1 | 0.5 | 56 |
| | joined particles | | | |
| A5 | Zinc oxide joined | 0.1 | 0.5 | 57 |
| | particles | | | |
| A6 | Silicon dioxide | 0.1 | 0.5 | 58 |
| | joined particles | | | |
| A7 | Silicon monoxide | 0.1 | 0.5 | 57 |
| | joined particles | | | |
| B1 | Alumina spherical | 0.5 | — | 44 |
| | particles | | | |
| B2 | Alumina aggregated | 0.1 | 0.5 | 45 |
| | particles | | | |
| | (vibration mill) | | | |
| B3 | Alumina aggregated | 0.1 | 0.5 | 44 |
| | particles (binder) | | | |

The evaluation results of the pastes A1 to A7 clearly illustrate that high porosity is obtained in the examples in which a joined-particle filler is used. The results also show that even when titanium oxide, zirconium oxide, magnesium oxide, zinc oxide, silicon dioxide or silicon monoxide is formed into joined particles, high porosity is obtained.

As comparative examples, the aggregated particles were produced by mechanical shearing using a vibration mill and another aggregated particles by using a binder. Both particles exhibited a low porosity. Qualitative analysis conducted using SEM revealed that the aggregated particles disintegrated into primary particles. This is presumably because the joined-particles of comparative examples received shearing force in the dispersing machine during the production of the slurry, whereby the particles disintegrated into primary particles.

In contrast, the joined particles produced by heating the pastes of the present invention A1 to A7 did not disintegrate even when they were dispersed by a typical dispersion method such as bead milling, and they formed a film having a high porosity, whereby the effect of the present invention was ascertained.

[Production of Lithium Ion Secondary Battery]

Using the pastes A1 to A7 and B1 to B3, batteries comprising a separator having a fine particulate filler-containing layer and a shutdown layer were produced. Then, the batteries were evaluated in terms of safety and charge/discharge characteristics.

A process for producing the batteries is described below.

(a) Production of Positive Electrode

A positive electrode material mixture slurry was prepared by mixing 3 kg of lithium cobalt oxide as a positive electrode active material, 1 kg of #1320 (trade name) available from Kureha Chemical Industry Co., Ltd. (an NMP solution containing 12 wt % PVDF) as a binder, 90 g of acetylene black as a conductive material and an appropriate amount of NMP with the use of a double arm kneader. This slurry was applied onto both surfaces of a 15 μm thick aluminum foil serving as a positive electrode current collector except for a positive electrode lead connecting portion. After drying, the films were rolled by rollers to form positive electrode material mixture layers, each having an active material layer density (the weight of active material/the volume of material mixture layer) of 3.3 g/cm³, during which the thickness of the electrode plate composed of the aluminum foil and the positive electrode material mixture layers was controlled to 160 μm. Then, the electrode plate was cut so as to have a width which allowed the insertion thereof into a battery can for a cylindrical battery (18650 type). Thereby, a positive electrode hoop was obtained.

(b) Production of Negative Electrode

A negative electrode material mixture slurry was prepared by mixing 3 kg of artificial graphite as a negative electrode active material, 75 g of BM-400B (trade name) available from Zeon Corporation, Japan (an aqueous dispersion containing 40 wt % modified form of styrene-butadiene copolymer) as a binder, 30 g of CMC as a thickener and an appropriate amount of water with the use of a double arm kneader. This slurry was applied onto both surfaces of a 10 Mm thick copper foil serving as a negative electrode current collector except for a negative electrode lead connecting portion. After drying, the films were rolled by rollers to form negative electrode material mixture layers, each having an active material layer density (the weight of active material/the volume of material mixture layer) of 1.4 g/cm³, during which the thickness of the electrode plate composed of the copper foil and the negative electrode material mixture layers was controlled to 180 μm. Then, the electrode plate was cut so as to have a width which allowed the insertion thereof into a battery can for a cylindrical battery (18650 type). Thereby, a negative electrode hoop was obtained.

(c) Production of Separator

A 15 μm thick microporous film made of polyethylene resin was used as a shutdown layer. The previously prepared paste was applied onto one surface of the shutdown layer using a bar coater at a rate of 0.5 m/min, which was then dried by blowing hot air at 80° C. at a rate of 0.5 m/sec so as to form a 5 μm thick fine particulate filler-containing layer comprising a fine particulate filler and a binder. Thereby, a separator for a test battery was obtained.

(d) Preparation of Non-aqueous Electrolyte

A non-aqueous electrolyte was prepared by dissolving LiPF₆ in a non-aqueous solvent of EC, DMC and EMC mixed at a volume ratio of 2:3:3 at a LiPF₆ concentration of 1 mol/L. Further, VC was added in an amount of 3 parts by weight per 100 parts by weight of the non-aqueous electrolyte.

(e) Production of Battery

Using the positive electrode, negative electrode and non-aqueous electrolyte produced above, 18650 type cylindrical batteries were produced in the following procedure. First, the positive electrode and the negative electrode were, cut into specified lengths, respectively. To the positive electrode lead connecting portion was connected an end of a positive electrode lead. To the negative electrode lead connecting portion was connected an end of a negative electrode lead. Thereafter, the positive electrode and the negative electrode were spirally wound with a separator having a fine particulate filler-containing layer and a shutdown layer so as to form a columnar electrode assembly. The outer surface of the electrode assembly was wrapped by the separator. This electrode assembly being sandwiched between an upper insulating ring and a lower insulating ring was housed into a battery can. Subsequently, the non-aqueous electrolyte prepared above was weighed to 5 g and then injected into the battery can. The pressure inside the battery can was reduced to 133 Pa so as to impregnate the electrode assembly with the non-aqueous electrolyte.

The other end of the positive electrode lead was welded to the underside of a battery lid. The other end of the negative electrode lead was welded to the inner bottom of the battery can. Finally, the opening of the battery can was sealed with the battery lid equipped with an insulating packing therearound. Thereby, a cylindrical lithium ion secondary battery having a theoretical capacity of 2 Ah was produced.

(I) Evaluation in terms of Irreversible Capacity

Each battery was subjected to two charge/discharge cycles, in each of which the charging was performed at a constant current of 400 mA with an end voltage of 4.1 V, and the discharging was performed at a constant current of 400 mA with an end voltage of 3 V. Then, in each cycle, a capacity difference was calculated by subtracting the discharge capacity from the charge capacity. The total of the capacity differences of the two cycles was referred to as “irreversible capacity”.

(II) Evaluation in Terms of Low Temperature Discharge Characteristics

After the calculation of the irreversible capacity, each battery in a charged state was stored in an environment of 45° C. for 7 days. Thereafter, the battery was subjected to the following charge/discharge cycles in an environment of 20° C.

(1) Constant current discharge: 400 mA (end voltage: 3 V)

(2) Constant current charge: 1400 mA (end voltage: 4.2 V)

(3) Constant voltage charge: 4.2 V (end current: 100 mA)

(4) Constant current discharge: 400 mA (end voltage: 3 V)

(5) Constant current charge: 1400 mA (end voltage: 4.2 V)

(6) Constant voltage charge: 4.2 V (end current: 100 mA)

Subsequently, the battery was allowed to stand for 3 hours, after which the battery was discharged in an environment of 0° C. under the following condition.

(7) Constant current discharge: 4000 mA (end voltage: 3 V)

The discharge capacity obtained by discharging at 2C rate at 0° C. was measured.

(III) Nail Penetration Test

Each battery was charged as follows.

(1) Constant current charge: 1400 mA (end voltage: 4.25 V)

(2) Constant voltage charge: 4.25 V (end current: 100 mA)

The charged battery was pierced by a round iron nail having a diameter of 2.7 mm from the side thereof in an environment of 20° C. at a speed of 5 mm/sec, and the heat generation was observed to determine the maximum temperature of the pierced portion of the battery that reached in 180 seconds.

### Examples 1 to 7

A lithium ion secondary battery was prepared in the same manner as described above using the paste A1 as a paste for forming the fine particulate filler-containing layer. This battery was referred to as a test battery of Example 1.

Likewise, lithium ion secondary batteries were produced in the same manner as in Example 1 except that the pastes A2, A3, A4, A5, A6 and A7 were used as pastes for forming the fine particular filler layer. These batteries were referred to as batteries of Examples 2, 3, 4, 5, 6 and 7, respectively.

### Comparative Examples 1 to 4

Lithium ion secondary batteries were produced in the same manner as in Example 1 except that the pastes B1, B2 and B3 were used as pastes for forming the fine particulate filler-containing layer. These batteries were referred to as batteries of Comparative Examples 1, 2 and 3, respectively. Another battery was produced using a separator comprising only a 20 μm thick microporous film made of polyethylene resin. This battery was referred to as battery of Comparative Example 4.

The batteries of Examples 1 to 7 and the batteries of Comparative Examples 1 to 4 were subjected to the same tests described in (I), (II) and (III) above so as to evaluate them in terms of battery performances and safety. The results are shown in Table 2.

TABLE 2

| | | Fine particulate filler-containing layer | | Maximum temperature in | 2C rate | Initial |
|---|---|---|---|---|---|---|
| | | Fine particulate filler | Amount of | nail penetration test | characteristics | irreversible |
| | Paste | material | binder (wt %) | (° C.) | at 0° C. (%) | capacity (mAh) |
| Ex. 1 | A1 | Alumina joined particles | 4 | 91 | 93 | 143 |
| Ex. 2 | A2 | Titanium oxide joined | 4 | 92 | 91 | 144 |
| | | particles | | | | |
| Ex. 3 | A3 | Zirconium oxide joined | 4 | 94 | 90 | 145 |
| | | particles | | | | |
| Ex. 4 | A4 | Magnesium oxide joined | 4 | 93 | 87 | 175 |
| | | particles | | | | |
| Ex. 5 | A5 | Zinc oxide joined particles | 4 | 92 | 88 | 162 |
| Ex. 6 | A6 | Silicon dioxide joined | 4 | 95 | 92 | 144 |
| | | particles | | | | |
| Ex. 7 | A7 | Silicon monoxide joined | 4 | 92 | 83 | 500 |
| | | particles | | | | |
| Comp. | B1 | Alumina spherical particles | 4 | 93 | 76 | 145 |
| Ex. 1 | | | | | | |
| Comp. | B2 | Alumina aggregated particles | 4 | 94 | 75 | 143 |
| Ex. 2 | | (vibration mill) | | | | |
| Comp. | B3 | Alumina aggregated particles | 4 | 93 | 74 | 143 |
| Ex. 3 | | (binder) | | | | |
| Comp. | — | — | — | Not less than | 94 | 152 |
| Ex. 4 | | | | 200° C. | | |

The results of the nail penetration test show that the battery of Comparative Example 4 having no fine particulate filler-containing layer exhibited a maximum battery temperature of not less than 180° C. In other words, overheating was observed. In contrast, in the batteries of Examples 1 to 7 and the batteries of Comparative Examples 1 to 3, their maximum battery temperatures could be reduced to less than 100° C. because their separators included the fine particulate filler-containing layer. The separator of Comparative Example 4 comprising only a shutdown layer heat-shrunk, expanding the short-circuited area between the positive and negative electrodes, which prolonged the short-circuit between the positive and negative electrodes. As a result, the battery overheated to not less than 180° C. In contrast, when the separators comprising the fine particulate filler-containing layer was used, because the fine particulate filler has high heat resistance, any heat shrinkage, any shape change such as thermal decomposition or any chemical reaction was not induced by Joule heat generated during the short-circuit, and thus the heat shrinkage of the separators was prevented. As a result, overheating did not occur in those batteries.

The batteries of Examples 1 to 7 containing a joined-particle filler exhibited 2C rate characteristics at 0° C. of not less than 80%, that is, they had superior discharge characteristics at a low temperature to those of the batteries of Comparative Examples 1 to 3. This is presumably because the fine particulate filler-containing layers of Examples 1 to 7 ensured a high porosity, whereas the spherical particles of Comparative Example 1, the aggregated particles of Comparative Example 2 produced by mechanical shearing and the aggregated particles of Comparative Example 3 bonded by a binder received shearing force in the dispersing machine during the preparation of the slurries, and they disintegrated into original primary particles. Consequently, the porosities of the fine particulate filler-containing layers of Comparative Examples 1 to 3 were as low as not greater than 45%. It can be surmised that such low porosity hinders lithium ions from migrating through the porous film in such a low temperature environment where the viscosity and conductivity of the electrolyte decrease. For this reason, the discharge characteristics lowered.

Although the battery of Example 7 was excellent in terms of safety and low temperature discharge characteristics, its initial irreversible capacity was large, so the theoretical capacity was not obtained. This is presumably because silicon monoxide reacted with lithium during the charge/discharge test, consuming reversible lithium to produce lithium oxide and a lithium-silicon alloy.

From the foregoing, it is clear that a highly safe battery having excellent electric characteristics can be obtained by incorporating a fine particulate filler-containing layer comprising a fine particulate filler and a binder and a shutdown layer, the fine particulate filler comprising a joined-particle filler that is in the form of a plurality of primary particles that are joined and bonded to one another. Further, because the joined particles in which the primary particles are partially melted and bonded to one another by a heat treatment do not disintegrate into primary particles even during the preparation of a slurry, high porosity can be ensured. When the fine particulate filler comprises at least one metal oxide selected from alumina, titanium oxide, zirconium oxide, magnesium oxide, zinc oxide and silicon dioxide, any side reaction that can harm the battery performance does not occur.

Investigations were made on the amount of the binder contained in a film comprising a fine particulate filler and a binder.

### Example 8

A paste for forming the fine particulate filler-containing layer was prepared in the same manner as the paste A1 was prepared except that the amount of the binder (i.e., polyacrylic acid derivative (MB-720H available from Zeon Corporation, Japan)) was changed to 1 part by weight per 100 parts by weight of the joined-particle filler. Then, a lithium ion secondary battery was produced in the same manner as in Example 1 except that the paste prepared above was used.

### Examples 9 to 14

Pastes for forming the fine particulate filler-containing layer were prepared in the same manner as the paste A1 was prepared except that the amount of the binder (i.e., polyacrylic acid derivative (MB-720H available from Zeon Corporation, Japan)) was changed to 1.5, 5, 8, 10, 15 or 50 parts by weight per 100 parts by weight of the joined-particle filler. Then, lithium ion secondary batteries were produced in the same manner as in Example 1 except that the pastes prepared above were used. The produced batteries were referred to as test batteries of Examples 9, 10, 11, 12, 13 and 14, respectively.

The batteries of Examples 8 to 14 were subjected to the same tests described in (I), (II) and (III) above so as to evaluate them in terms of battery performances and safety. The results are shown in Table 3.

TABLE 3

| | Fine particulate filler-containing layer | | Maximum temperature in | 2C rate | Initial |
|---|---|---|---|---|---|
| | Fine particulate filler | Amount of | nail penetration test | characteristics | irreversible |
| | material | binder (wt %) | (° C.) | at 0° C. (%) | capacity (mAh) |
| Ex. 8 | Alumina joined particles | 1 | 152 | 94 | 143 |
| Ex. 9 | Alumina joined particles | 1.5 | 98 | 94 | 142 |
| Ex. 1 | Alumina joined particles | 4 | 91 | 93 | 143 |
| Ex. 10 | Alumina joined particles | 5 | 92 | 92 | 144 |
| Ex. 11 | Alumina joined particles | 8 | 94 | 91 | 143 |
| Ex. 12 | Alumina joined particles | 10 | 95 | 89 | 142 |
| Ex. 13 | Alumina joined particles | 15 | 134 | 82 | 143 |
| Ex. 14 | Alumina joined particles | 50 | 160 | 80 | 143 |

As can be seen from Table 3, the batteries of Examples 8 to 14 exhibited excellent results with a maximum temperature in the nail penetration test of less than 180° C. and 2C rate characteristics at 0° C. of not less than 80%. Further, no overheating was observed. However, in Example 8 in which the amount of binder was less than 1.5 parts by weight relative to 100 parts by weight of the joined-particle filler, and in Examples 13 and 14 in which the amount of binder was over 10 parts by weight, the maximum temperature in the nail penetration test was not less than 130° C. Usually, most battery cases which are actually mounted to portable devices are made of polycarbonate having a softening point of about 105 to 150° C. Accordingly, such battery whose temperature increases to a temperature at which the battery case may deform is not preferred for practical use.

The reason for the above results is considered as follows. When the amount of binder was not less than 1.5 parts by weight per 100 parts by weight of the joined-particle filler, the adhesion strength of the porous film containing a fine particulate filler and a binder with the shutdown layer was sufficiently high. Accordingly, even when meltdown phenomenon occurred in the shutdown layer in a high temperature condition caused by a short-circuit of the battery, the porous film containing a fine particulate filler and a binder did not separate from the shutdown layer.

When the amount of binder exceeded 10 parts by weight per 100 parts by weight of the joined-particle filler, because the relative amount of the fine particulate filler was small and the phenomenon in which the binder and the shutdown layer heat-shrink occurred easily, sufficient heat resistance was not retained, which prolonged the short-circuit time of the battery. When the amount of binder was not greater than 10 parts by weight per 100 parts by weight of the joined-particle filler, no significant reduction in porosity of the porous film containing the fine particulate filler and the binder caused by increasing the amount of binder occurred, and therefore excellent battery performance was obtained.

Investigations were made on separators whose fine particulate filler-containing layer was a heat resistant porous film comprising a fine particulate filler and a heat resistant resin.

### Example 15

A method for producing the separators is described below.

As a heat resistant resin material, aramid resin was used. This resin had a heat deflection temperature (determined by deflection temperature measurement under load of 1.82 MPa according to a test method ASTM-D648) of over 320° C.

The aramid resin was produced as follows. First, NMP in an amount of 100 parts by weight was mixed with 6.5 parts by weight of dried anhydrous calcium chloride in a reaction vessel, which was heated, and they were dissolved completely. This NMP solution containing calcium chloride was then cooled to room temperature, after which 3.2 parts by weight of paraphenylenediamine (PPD) was added thereto and dissolved completely. The reaction vessel was then placed in a thermostatic chamber maintained at 20° C. Dichloride terephthalate (TPC) in an amount of 5.8 parts by weight was added dropwise over one hour to cause a polymerization reaction to synthesize polyparaphenylene terephthalamide (PPTA). The reaction vessel was allowed to stand for one hour in the thermostatic chamber. After the completion of the reaction, the reaction vessel was transferred to a vacuum chamber, and stirred under a reduced pressure for 30 minutes for degassing. The obtained polymerized solution was diluted with another NMP solution containing calcium chloride so as to obtain an NMP solution containing aramid resin having a PPTA concentration of 1.4 wt %.

Subsequently, 100 parts by weight of alumina joined particles used for the preparation of the paste A1 in Example 1 was introduced into the above-prepared NMP solution containing aramid resin such that the aramid resin content was 50 parts by weight in the NMP solution, which was then stirred for 60 minutes to prepare a paste containing the fine particulate filler.

As the shutdown layer, a 15 μm thick microporous film made of polyethylene resin was used. The above-prepared paste containing the fine particulate filler was applied onto one surface of this shutdown layer using a bar coater at a rate of 0.5 m/min, which was then dried by blowing hot air at 80° C. at a rate of 0.5 m/sec so as to form a 5 μm thick fine particulate filler-containing layer containing the fine particulate filler and the heat resistant resin.

A lithium ion secondary battery was produced in the same manner as in Example 1 except that the separator thus obtained was used.

### Examples 16 to 21

Lithium ion secondary batteries were produced in the same manner as in Example 15 except that, as the fine particulate filler, titanium oxide joined particles used for the preparation of the paste A2 in Example 2, zirconium oxide joined particles used for the preparation of the paste A3 in Example 3, magnesium oxide joined particles used for the preparation of the paste A4 in Example 4, zinc oxide joined particles used for the preparation of the paste A5 in Example 5, silicon dioxide joined particles used for the preparation of the paste A6 in Example 6 and silicon monoxide joined particles used for the preparation of the paste A7 in Example 7 were used. These batteries were referred to as batteries of Examples 16, 17, 18, 19, 20 and 21, respectively.

### Comparative Examples 5 to 7

Lithium ion secondary batteries were produced in the same manner as in Example 15 except that, as the fine particulate filler, alumina spherical particles used for the preparation of the paste B1 in Comparative Example 1, alumina aggregated particles used for the preparation of the paste B2 in Comparative Example 2 and alumina aggregated particles used for the preparation of the paste B3 in Comparative Example 3 were used. These batteries were referred to as test batteries of Comparative Examples 5, 6 and 7, respectively.

### Example 22

As a heat resistant resin material for a separator of this example, polyimide resin was used. This resin had a heat deflection temperature (determined by deflection temperature measurement under load of 1.82 MPa according to a test method ASTM-D648) of over 360° C.

A polyamide acid solution, a precursor for polyimide, was mixed with alumina joined particles used for the preparation of the paste A1 in Example 1. The resultant was then subjected to casting and drawing to produce a porous thin film. This thin film was heated to 300° C. for dehydration to form an imide. Thereby, a 6 μm thick heat resistant porous film containing the fine particulate filler and the polyimide resin was obtained.

This heat resistant porous film was analyzed for the amount of alumina remained by a combustion method, and it was found that the porous film contained 60 parts by weight of polyimide resin relative to 100 parts by weight of the fine particulate filler.

The above heat resistant porous film was placed on a 15 μm thick microporous film made of polyethylene resin, which was then rolled by heat rollers heated at 80° C. Thereby, a separator of this example was obtained. A lithium ion secondary battery was produced in the same manner as in Example 15 except that this separator was used.

### Example 23

As a heat resistant resin material for a separator of this example, polyamide imide resin was used. This resin had a heat deflection temperature (determined by deflection temperature measurement under load of 1.82 MPa according to a test method ASTM-D648) of over 278° C.

An NMP solution containing polyamide acid was prepared by mixing trimellitic anhydride monochloride and diamine in an NMP solution at room temperature.

Subsequently, 100 parts by weight of alumina joined particles used for the preparation of the paste A1 in Example 1 was introduced into the above-prepared NMP solution containing polyamide acid such that the amount of the polyamide acid was 50 parts by weight in the NMP solution, which was then stirred for 60 minutes to prepare a paste containing the fine particulate filler.

As the shutdown layer, a 15 μm thick microporous film made of polyethylene resin was used. The above-prepared paste containing the fine particulate filler was applied onto one surface of this shutdown layer using a bar coater at a rate of 0.5 m/min, which was then washed with water to remove the solvent. Then, hot air at 80° C. was blown at a rate of 0.5 m/sec for cyclodehydration to produce polyamide imide. Thereby, a 5 μm thick fine particulate filler-containing layer containing the fine particulate filler and the heat resistant resin was formed.

A lithium ion secondary battery was produced in the same manner as in Example 15 except that the separator thus obtained was used.

### Example 24

As a heat resistant resin material for a separator of this example, polyarylate resin was used. This resin had a heat deflection temperature (determined by deflection temperature measurement under load of 1.82 MPa according to a test method ASTM-D648) of over 175° C.

At room temperature, bisphenol A dissolved in an aqueous alkaline solution was reacted with a mixture prepared by dissolving terephthaloyl chloride and isophthaloyl chloride in halogenated hydrocarbon (ethylene dichloride) as an organic solvent so as to synthesize polyarylate in the organic solvent phase. Into this halogenated hydrocarbon solution with polyarylate dispersed therein was introduced the alumina joined particles used for the preparation of the paste A1 in Example 1 such that the amount of the alumina joined particles was 100 parts by weight relative to 50 parts by weight of polyarylate, which was then stirred for 60 minutes to prepare a paste containing the fine particulate filer.

Subsequently, the paste containing the fine particulate filler was applied, by a bar coater, onto one surface of a 15 μm thick microporous film made of polyethylene resin serving as the shutdown layer to form a thin coating. After the solvent was removed using toluene as a cleaner, hot air at 80° C. was blown at a rate of 0.5 m/sec to dry it. Thereby, a separator of this example was obtained.

A lithium ion secondary battery was produced in the same manner as in Example 15 except that the separator thus obtained was used.

### Comparative Example 8

As a resin material for a separator of this comparative example, polyvinylidene fluoride resin was used. This resin had a heat deflection temperature (determined by deflection temperature measurement under load of 1.82 MPa according to a test method ASTM-D648) of 115° C.

Into an NMP solution of polyvinylidene fluoride was introduced the alumina joined particles used for the preparation of the paste A1 in Example 1 such that the amount of polyvinylidene fluoride was 60 parts by weight relative to 100 parts by weight of the alumina joined particles, which was then stirred for 60 minutes to prepare a paste containing the fine particulate filler.

Subsequently, the paste containing the fine particulate filler was applied, by a bar coater, onto one surface of a 15 μm thick microporous film made of polyethylene resin serving as the shutdown layer at a rate of 0.5 m/min, which was then dried by blowing hot air at 80° C. at a rate of 0.5 m/sec to form a 5 μm thick fine particulate filler-containing layer containing the fine particulate filler and the heat resistant resin.

A lithium ion secondary battery was produced in the same manner as in Example 15 except that the separator thus obtained was used.

### Comparative Example 9

A lithium ion secondary battery was produced in the same manner as in Example 15 except that a separator in which a heat resistant resin film was formed on the shutdown layer without introducing the fine particulate filler in Example 15 was used.

The batteries of Examples 15 to 24 and Comparative Examples 5 to 9 were subjected to the same tests described in (I), (II) and (III) above so as to evaluate them in terms of battery performances and safety. The results are shown in Table 3.

TABLE 4

| | Fine particulate filler-containing layer | | Maximum temperature in | 2C rate | Initial |
|---|---|---|---|---|---|
| | Fine particulate filler | Heat resistant | nail penetration test | characteristics | irreversible |
| | material | resin material | (° C.) | at 0° C. (%) | capacity (mAh) |
| Ex. 15 | Alumina joined particles | Aramid | 86 | 91 | 142 |
| Ex. 16 | Titanium oxide joined particles | Aramid | 87 | 89 | 145 |
| Ex. 17 | Zirconium oxide joined particles | Aramid | 89 | 88 | 142 |
| Ex. 18 | Magnesium oxide joined particles | Aramid | 89 | 85 | 176 |
| Ex. 19 | Zinc oxide joined particles | Aramid | 87 | 86 | 165 |
| Ex. 20 | Silicon dioxide joined particles | Aramid | 90 | 90 | 149 |
| Ex. 21 | Silicon monoxide joined particles | Aramid | 87 | 81 | 500 |
| Comp. | Alumina spherical particles | Aramid | 89 | 74 | 143 |
| Ex. 5 | | | | | |
| Comp. | Alumina aggregated particles | Aramid | 89 | 73 | 145 |
| Ex. 6 | (vibration mill) | | | | |
| Comp. | Alumina aggregated particles | Aramid | 89 | 72 | 146 |
| Ex. 7 | (binder) | | | | |
| Ex. 22 | Alumina joined particles | Polyimide | 83 | 85 | 143 |
| Ex. 23 | Alumina joined particles | Polyamide | 89 | 86 | 145 |
| | | imide | | | |
| Ex. 24 | Alumina joined particles | Polyarylate | 135 | 86 | 145 |
| Comp. | Alumina joined particles | Polyvinylidene | Not less than | 84 | 150 |
| Ex. 8 | | fluoride | 200° C. | | |
| Comp. | — | Aramid | 84 | 61 | 145 |
| Ex. 9 | | | | | |

As is clear from Table 4, the batteries of Examples 15 to 21 and 22 to 24 containing the joined-particle filler exhibited more excellent low temperature discharge characteristics with 2C rate characteristics at 0° C. of not less than 80% as compared to the batteries of Comparative Examples 5 to 7. This is because, in the batteries of Examples 15 to 21 and 22 to 24, the porous films ensured a high porosity. On the other hand, the battery of Comparative Example 5 containing spherical particles and the batteries of Comparative Examples 6 and 7 containing aggregated particles exhibited low discharge characteristics, which may be due to low porosity of the porous film. This is presumably because the aggregated particles received shearing force in the dispersing machine and they disintegrated into original primary particles.

The battery of Example 21 was excellent in terms of safety and low temperature discharge characteristics, but its initial irreversible capacity was large and the theoretical capacity was not obtained. Presumably, this is because silicon monoxide reacted with lithium during the charge/discharge test, consuming reversible lithium to produce lithium oxide and a lithium-silicon alloy.

The batteries of Examples 15, 22 and 23 in which a heat resistant resin having a heat deflection temperature of 180° C. or higher was used as the binder exhibited a high level of safety with a maximum temperature in the nail penetration test of not greater than 100° C. In contrast, although the battery of Example 24 in which polyarylate having a heat deflection temperature of not less than 175° C. was used did not overheat to 180° C. or higher, it exhibited a maximum temperature in the nail penetration test of 135° C. The reason can be explained as follows. Joule heat occurred in the area where an internal short-circuit occurred by the penetration of the nail, which locally increased the temperature to a high level. Because the heat deflection temperature was about 175° C., the phenomenon in which the shutdown layer heat-shrunk occurred easily, sufficient heat resistance was not retained, which prolonged the short-circuit time of the battery.

The polyvinylidene fluoride resin having a heat deflection temperature of 115° C. used in Comparative Example 8 offered little heat resistance. As such, the battery of Comparative Example 8 exhibited a high maximum temperature in the nail penetration of not less than 200° C. In other words, excellent safety was not obtained. In the battery of Comparative Example 9 in which a separator having the shutdown layer and a heat resistant resin film containing no fine particulate filler was used, high porosity could not be ensured, and thus low temperature discharge characteristics were extremely low.

The foregoing clearly indicates that a battery having a high level of safety and excellent electrical characteristics can be obtained by incorporating a shutdown layer and a fine particle filler-containing layer comprising a heat resistant porous film containing a fine particulate filler and a heat resistant resin, the fine particulate filler comprising a joined-particle filler that is in the form of a plurality of primary particles that are joined and bonded to one another. In the joined particles, the primary particles are partially melted and bonded to one another by a heat treatment, and thus the joined particles do not disintegrate into primary particles even during the preparation of a slurry. Accordingly, a film having a high porosity can be formed.

The foregoing also indicates that the fine particulate filler preferably comprises at least one metal oxide selected from alumina, titanium oxide, zirconium oxide, magnesium oxide, zinc oxide and silicon dioxide because they does not cause any side reaction that can harm battery performance.

Further, using, as a binder, a heat resistant resin having a heat deflection temperature of 180° C. or higher determined by deflection temperature measurement under load of 1.82 MPa according to ASTM-D648, it is possible to yield a battery having a high level of safety.

Subsequently, investigations were made on the amount of the heat resistant resin for use in the film containing a fine particulate filler and a heat resistant resin. Although the examples given below utilized aramid resin, the effect of the present invention does not vary according to the resin material used.

### Example 25

A paste for forming the fine particulate filler-containing layer was prepared and a separator was produced in the same manner as in Example 15 except that 5 parts by weight of the aramid resin serving as the heat resistant resin was used relative to 100 parts by weight of the joined-particle filler. A lithium secondary battery was produced in the same manner as in Example 15 except that this separator was used.

### Examples 26 to 30

Lithium ion secondary batteries were produced in the same manner as in Example 25 except that the amount of the aramid resin was changed to 10, 20, 100, 200 and 300 parts by weight relative to 100 parts by weight of the joined-particle filler to prepare pastes for forming the fine particulate filler-containing layer. These batteries were used as test batteries 26, 27, 28, 29 and 30, respectively.

The batteries of Examples 15 and 25 to 30 were subjected to the same tests described in (I), (II) and (III) above so as to evaluate them in terms of battery performances and safety. The results are shown in Table 5.

TABLE 5

| | Fine particulate filler-containing layer | | Maximum temperature in | 2C rate | Initial |
|---|---|---|---|---|---|
| | Fine particulate filler | Amount of aramid | nail penetration test | characteristics | irreversible |
| | material | resin (wt %) | (° C.) | at 0° C. (%) | capacity (mAh) |
| Ex. 25 | Alumina joined particles | 5 | 132 | 94 | 140 |
| Ex. 26 | Alumina joined particles | 10 | 96 | 93 | 142 |
| Ex. 27 | Alumina joined particles | 20 | 93 | 93 | 143 |
| Ex. 15 | Alumina joined particles | 50 | 86 | 91 | 142 |
| Ex. 28 | Alumina joined particles | 100 | 85 | 84 | 141 |
| Ex. 29 | Alumina joined particles | 200 | 85 | 82 | 142 |
| Ex. 30 | Alumina joined particles | 300 | 84 | 71 | 143 |

As can be seen from the above results, any of the batteries of Examples 15 and 25 to 30 did not overheat to 180° C. or higher during the nail penetration test. In addition, they also exhibited excellent 2C rate characteristics at 0° C. of not less than 80%. However, the battery of Example 25, in which the amount of the heat resistant resin was less than 10 parts by weight relative to 100 parts by weight of the joined-particle filler, exhibited a high maximum temperature in the nail penetration test of not less than 130° C. Usually, most battery cases which are actually mounted to portable devices are made of polycarbonate having a softening point of about 105 to 150° C. Accordingly, such battery whose temperature increases to a temperature at which the battery case may deform is not preferred for practical use.

When the amount of the heat resistant resin is less than 10 parts by weight relative to 100 parts by weight of the joined-particle filler, the adhesion strength between the shutdown layer and the porous film containing the fine particulate filler and the heat resistant resin is not sufficient. If the meltdown phenomenon occurs in the shutdown layer in a high temperature condition during a short-circuit of the battery, the porous film containing the fine particulate filler separates from the shutdown layer, and thus heat shrinkage cannot be prevented sufficiently.

Conversely, when the amount of the heat resistant resin is not greater than 200 parts by weight relative to 100 parts by weight of the joined-particle filler, excellent battery performance is obtained because a significant reduction in porosity of the porous film containing the fine particulate filler and the binder caused by increasing the amount of the binder does not occur.

Subsequently, investigation was made on a separator having a layer without shutdown function.

### Comparative Example 10

A separator was produced and a lithium ion secondary battery was produced in the same manner as in Example 1 except that, instead of the 15 μm thick microporous film made of polyethylene resin, a 20 μm thick polyethylene terephthalate non-woven fabric (softening point: 238° C.) was used as the shutdown layer. The produced battery of Comparative Example 10 was subjected to the same tests described in (I), (II) and (III) above so as to evaluate in terms of battery performances and safety. The results are shown in Table 6.

TABLE 6

| | | Fine particulate | | | |
|---|---|---|---|---|---|
| | | filler-containing | | | |
| | | layer | Maximum temperature in | 2C rate | Initial |
| | Material for | Fine particulate | nail penetration test | characteristics | irreversible |
| | shutdown layer | filler material | (° C.) | at 0° C. (%) | capacity (mAh) |
| Ex. 1 | Polyethylene | Alumina joined | 91 | 93 | 143 |
| | | particles | | | |
| Comp. | Polyethylene | Alumina joined | Not less than | 92 | 142 |
| Ex. 10 | terephthalate | particles | 200° C. | | |
| | non-woven fabric | | | | |

The above table shows that when a polyethylene terephthalate non-woven fabric that does not perform the shutdown function at a temperature of 80 to 180° C. is used as in Comparative Example 10, the battery exhibits a maximum temperature in the nail penetration test of not less than 180° C., which indicates that the battery overheats. When an internal short-circuit occurs by the penetration of a nail, the heat shrinkage of the separator is prevented because of the presence of the fine particulate filler-containing layer. However, unlike the porous film of a polyolefin such as polyethylene, the polyethylene terephthalate non-woven fabric did not perform the shutdown function, and therefore Joule heat occurred by an extremely weak short-circuit current that kept flowing increased the battery temperature to not less than 180° C. and led to the overheating of the battery.

Further, lithium ion secondary batteries were produced in the same manner as in Example 1 except that the paste A1 of Example 1 containing the fine particulate filler and the binder was applied onto, instead of the shutdown layer serving as a separator, the positive electrode plate or the negative electrode in the formation of a porous film containing the fine particulate filler. The obtained batteries were subjected to the same evaluation tests. As a result, the test battery in which the paste was applied onto the positive electrode plate and the test battery in which the paste was applied onto the negative electrode plate both exhibited a maximum temperature in the nail penetration test of not greater than 100° C., 2C rate characteristics at 0° C. of not less than 90% (i.e., great low temperature discharge characteristics) and a small irreversible capacity similar to the battery of Example 1. In other words, batteries having excellent characteristics were obtained.

However, when the above test batteries and the battery of Example 1 were further subjected to a heat resistance test in which each battery was heated to 150° C., the test battery of Example 1 exhibited a maximum battery temperature in the nail penetration test of only 162° C., whereas the test battery in which the paste was applied onto the positive electrode plate and the test battery in which the paste was applied onto the negative electrode plate both overheated to 180° C. or higher. This is because, in the high temperature heating test in which the batteries were heated to 150° C., the porous polyolefin serving as the shutdown layer heat shrunk, and a behavior in which the positive and negative electrodes were short-circuited at the ends of the electrode group occurred.

In contrast, in the present invention, because the fine particulate filler-containing layer is bonded onto the shutdown layer, the heat shrinkage of the shutdown layer can be suppressed not only in the event of an internal short-circuit but also in a high temperature environment as described above. When the fine particulate filler-containing layer is formed on the positive or negative electrode plate, on the other hand, because the heat shrinkage of the shutdown layer cannot be suppressed, an area where the positive and negative electrodes face each other is formed. In this case, an area having no fine particulate filler applied thereon may occur locally due to the protrusions and recesses of the active material contained in the electrode. In such a case, because sufficient insulation between the positive and negative electrodes cannot be retained in an area where the separator is not present due to the heat shrinkage thereof, the positive and negative electrodes may be short-circuited, causing Joule heat and leading to overheating. As described above, by using a separator having the fine particulate filler-containing layer and the shutdown layer, a high level of safety can be obtained.

### INDUSTRIAL APPLICABILITY

According to the present invention, it is possible to ensure high safety and improved large current discharge characteristics particularly at low temperatures. Therefore, the present invention is useful particularly as a power source for portable devices. Although the present invention is applicable to any secondary batteries, the present invention is particularly suitable for use in a lithium ion secondary battery that requires a high level of safety comprising an electrolyte containing a flammable organic non-aqueous solvent.

1. A separator comprising: at least
a layer comprising a fine particulate filler; and
a shutdown layer,
wherein said fine particulate filler comprises a joined-particle filler that is in the form of a plurality of primary particles that are joined and bonded to one another.

2. The separator in accordance with claim 1,
wherein, in said joined-particle filler, said plurality of primary particles are partially melted and bonded to one another due to a heat treatment.

3. The separator in accordance with claim 1,
wherein said fine particulate filler comprises at least one metal oxide selected from the group consisting of alumina, titanium oxide, zirconium oxide, magnesium oxide, zinc oxide and silicon dioxide.

4. The separator in accordance with claim 1,
wherein said fine particle filler-containing layer is a porous film comprising said fine particulate filler and a binder or a heat resistant porous film comprising said fine particulate filler and a heat resistant resin.

5. The separator in accordance with claim 4,
wherein said porous film contains said binder in an amount of not less than 1.5 parts by weight and not greater than 10 parts by weight relative to 100 parts by weight of said fine particulate filler.

6. The separator in accordance with claim 4,
wherein said heat resistant resin contained in said heat resistant porous film has a heat deflection temperature of 180° C. or higher determined by deflection temperature measurement under load of 1.82 MPa according to ASTM-D648 defined by American Society for Testing and Materials, and
the amount of said heat resistant resin is not less than 1.5 parts by weight and not greater than 200 parts by weight relative to 100 parts by weight of said fine particulate filler.

7. The separator in accordance with claim 1,
wherein said shutdown layer is a porous film comprising a thermoplastic resin and is capable of turning into a substantially nonporous layer at a temperature of 80 to 180° C.

8. A non-aqueous electrolyte secondary battery comprising a positive electrode, a negative electrode, a separator and a non-aqueous electrolyte,
wherein said separator is the separator in accordance with claim 1.
